(19) United States
(12) Patent Application Publication
(10) Pub. No.: US 2018/0004908 A1
(43) Pub. Date: Jan. 4, 2018

(54) Telemedicine System

(71) Applicant: SIERRA NEVADA CORPORATION, Sparks, NV (US)

(72) Inventors: Joseph Peter Barrus, Sparks, NV (US); Steven Dean Miller, Sparks, NV (US); David Kent Jones, Sparks, NV (US); Kyle Anthony Stanton, Sparks, NV (US)

(73) Assignee: SIERRA NEVADA CORPORATION, Sparks, NV (US)

(21) Appl. No.: 15/535,628

(22) PCT Filed: Dec. 17, 2015
(86) PCT No.: PCT/US15/66275

§ 371 Date: Jun. 13, 2017

Related U.S. Application Data
(60) Provisional application No. 62/094,853, filed on Dec. 19, 2014.

(51) Int. Cl. G06F 19/00; H04W 24/08; H04W 76/02

(52) U.S. Cl. CPC G06F 19/3418; H04W 24/08; G06F 19/322; G06F 19/3406; H04W 76/028

(57) ABSTRACT

A system is configured for accessing, editing, managing and/or observing medical related data. The system includes one or more computing devices that interact with one or more medical devices with respect to medical data. The data can be transmitted over a communication network, which can be coupled to or include the Internet or any other computer network.

### REFERENCE TO RELATED APPLICATIONS

This application claims priority to U.S. Patent Application Ser. No. 62/094,853 entitled “Telemedicine System” and filed on Dec. 19, 2014. Priority to the aforementioned filing date is claimed and the provisional application is incorporated by reference in its entirety.

This application is related to U.S. patent application Ser. No. 14/263,686 entitled “Patient Medical Data Access Software” filed on Apr. 28, 2014 and U.S. patent application Ser. No. 14/166,272 entitled “Patient Medical Data Access System” filed on Jan. 28, 2014, both of which are incorporated herein by reference in their entirety.

### BACKGROUND

Medical service providers, such as physicians and emergency medical technicians (EMTs), are often out on the field in a non-hospital setting when providing medical services to a patient. In a modern environment, the medical service provider often has access to a computer or other computing device, which is used to access and distribute medical-related data and to also communicate with one or more other service providers located at a remote location.

With regard to the accessing and distribution of data, the medical service provider may sometimes be in a location that does not provide adequate access to a telecommunication network. This can create problems in terms of accessing, storing, and distributing the data and can create a situation where the medical service provider cannot adequately update the data over the network. In view of this, there is a need for systems and methods that would enable a medical service provider to properly manage medical related data in situations or communication network access is limited or unavailable.

It can also be difficult for the medical service provider to transfer data from a medical device to computer particularly when there is a variety of medical devices that need to transfer data to the computer. It would be helpful for the medical service provider to have an agnostic and user-friendly interface for transferring data from a medical device to a computer or application on the computer.

### BRIEF DESCRIPTION OF THE DRAWINGS

Generally speaking the figures are not to scale in absolute terms or comparatively but are intended to be illustrative. Also, relative placement of features and elements may be modified for the purpose of illustrative clarity.

FIG. 1 shows an example topology of a telemedicine system.

FIG. 2 shows a flow chart of an exemplary method of data throttling.

FIG. 3 shows an example of a method for queueing data.

FIG. 4 shows a schematic representation of an example architecture for implementing data replication and synchronization.

FIG. 5A and FIG. 5B show representations of exemplary methods of implementing processes both for sending data and receiving data.

FIG. 6 shows an exemplary topology for implementation of a medical agnostic device interface.

FIGS. 7-11 show examples of a user interface for accessing, storing, and distributing medical related data.

### DETAILED DESCRIPTION

Disclosed is a system for accessing, editing, managing and/or observing medical related data. The system includes one or more computing devices that interact with one or more medical devices with respect to medical data. The data can be transmitted over a communication network (sometimes referred to as a telemedicine network), which can be coupled to or include the Internet or any other computer network. A telemedicine network includes a connection via the Internet or other computer network connection that provides a data connection from a local device or software to an Electronic Healthcare Record Repository controlled by a primary healthcare provider or other entity. The network also includes one or more devices that can access the connection and communicate with other devices. An electronic healthcare record (EHR) is a record that is maintained for all patients controlled by a primary healthcare provider.

Pursuant to the transmission of data, the system uses a data throttling mechanism to prioritize data during or before transmission based on available bandwidth to the network and also based on a priority scheme. When transmitting in low bandwidth environments, data only categorized as high priority may be transmitted and received. As bandwidth increases, lower priority data is transmitted over the network connection. As bandwidth decreases, lower priority data is held back in order to transmit high priority data. Data priority can be reclassified as a higher or lower priority depending on individual need as the application or environment dictates.

The system also uses a Data Replication and Synchronization (DR&S) methodology for storing data in a local location until bandwidth or network connectivity allows for synchronization to take place over an available network. A DR&S server maintains confidentiality compliance by encrypting all data at rest and removing files that are no longer required that have been verified as synchronized with a Healthcare Record Repository, as described in more detail below.

Data Throttling

Software of the system is configured to adjust the flow of data to or from a home base, which can be any device or location that has access to the network. In an embodiment the home base is at least partially comprised of a healthcare facility and/or a computer at the healthcare facility. The disclosed processes maximize or otherwise increase the likelihood of successful transmission of the data over the network from a first location to a second location such as the home base. This is done by attempting to match or otherwise optimize sent data volume to available communication bandwidth. In this regard, the software is configured to perform one or more operations for adjusting the flow of data over the network.

The software stores patient data in a data structure wherein the patient data is organized into one or more medical or patient data elements. Each patient data element is associated with a ‘priority’ wherein the priority indicates a relative value or importance of the patient data element relative to one or more other data elements. The priority may vary and may be associated with a situational awareness focused on providing the best care possible.

The priority value may range from a value associated with a highest (or most important priority) to a value associated with a lowest (or least important) priority. For example, the priority may range from one (1) for a “high” priority value to five (5) for a “low” priority value with intermediate values 2, 3, and 4 ranging between the two. This is just an example and it should be appreciated that the range in increments of priority values may vary as may nomenclature associated with priority values.

A patient data element may be any piece of information that is relevant to patient care and/or treatment. For example, a patient data element may relate to or indicate a patient's blood pressure reading or any other data associated with the patient or the patient's environment. Other examples include the patient's weight, height, age, body temperature, location of the patient, etc.

In an example of the patient's blood pressure, the patient's blood pressure may be assigned, for example, a priority of one (1) while one or more other factors or details related to a patient care situation or related to the environment or location may be given a lower priority. The actual patient data elements and the corresponding priority value may be assigned in a variety of manners. An expert in the care of critical patients may define a default set of priorities while a care provider or other entity at the point of care location may be able to edit the priority value of each patient data element. Each patient data element may also have an associated timestamp indicating when that piece of information was captured.

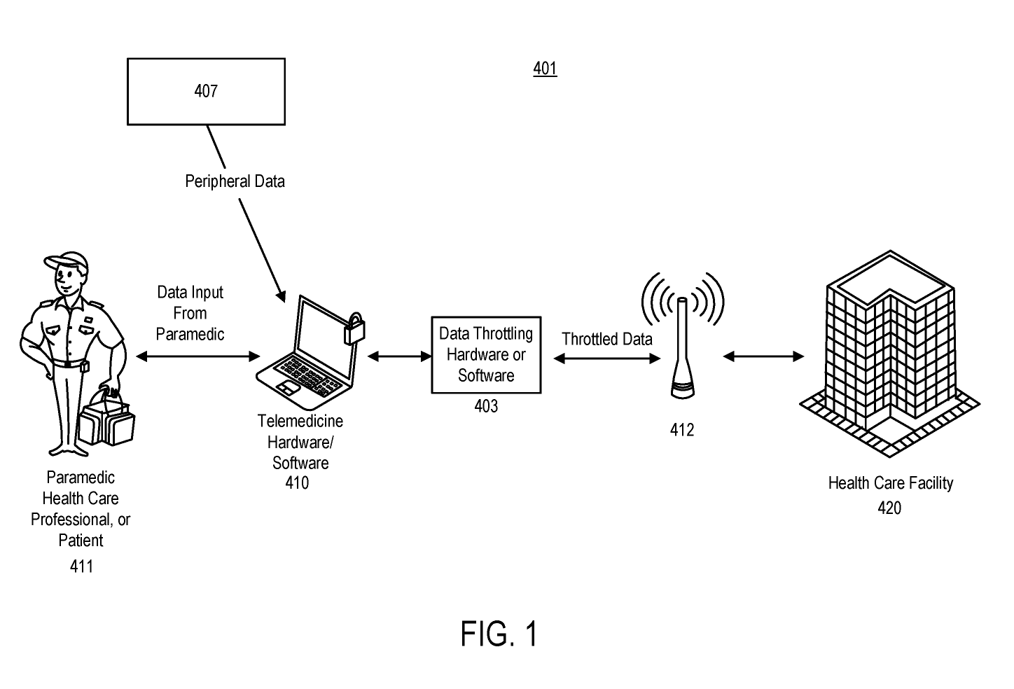

Data throttling is enabled through any of a variety of configurations that are implement via hardware and/or software. FIG. 1 shows an example topology of how the disclosed telemedicine system 401 may be configured. The topology includes a software and/or hardware data throttling module 403 that enables data throttling. The data throttling module 403 can reside for example on the local hardware device, such as on a computer or handheld device.

With reference still to FIG. 1, the system 401 includes one or more telemedicine or medical device peripherals 407, which may include any of a variety of medical device(s) that communicatively (in a wired and/or wireless manner) attach to a telemedicine hardware and/or software device 410 such as a mobile computer. The telemedicine or medical device peripherals can transfer data to and from the telemedicine hardware and/or software device 410, which can also receive data from a healthcare provider such as, for example, a paramedic 411. In an embodiment, the paramedic 411 provides data to the device 410 by entering data via a keypad, microphone, mouse, or any other type of data entry device for example. The data throttling module 403 communicates with a communication network 412 such as the Internet via a wired or wireless connection. A healthcare facility 420 can also communicate with the network 412, such as via a computer or other device connected to the network 412.

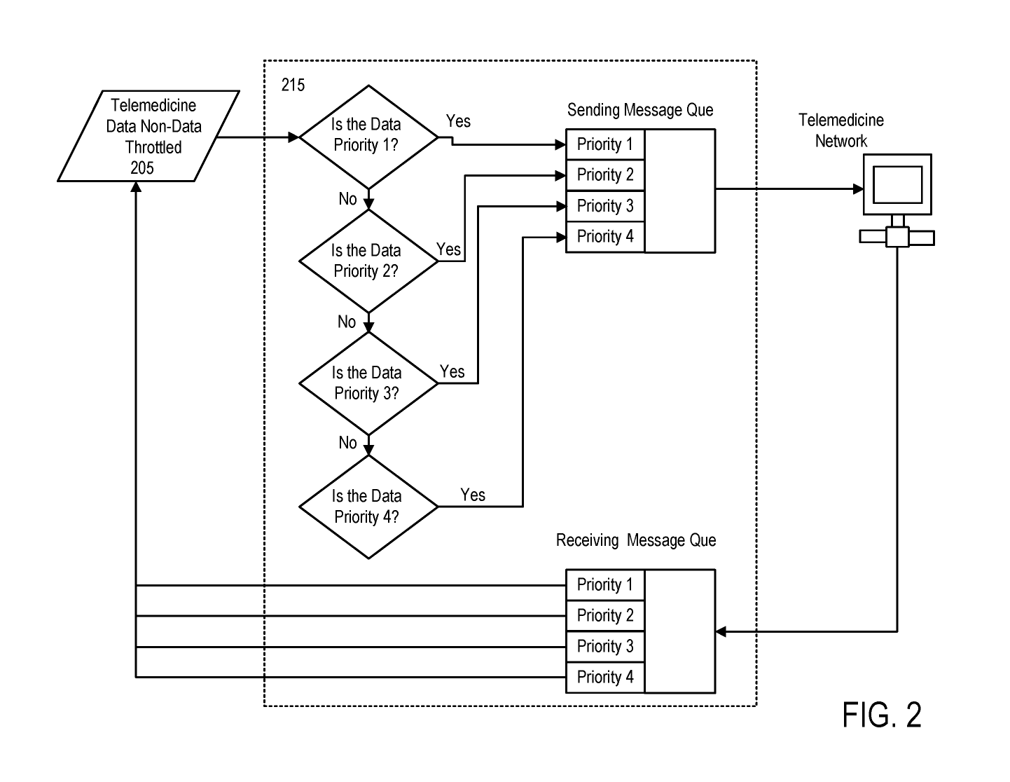

FIG. 2 shows a flow chart of an exemplary method of how data throttling is implemented in hardware and/or software. It should be appreciated that the flow chart of FIG. 2 is only an example and that it is not limiting on this disclosure. The method may include additional steps or some of the step shown in FIG. 2 may be deleted and still be within the scope of this disclosure to suit a specific implementation.

In an initial process 205, the system is provided access to patient data prior to the data being throttled. The patient data is passed to the throttling software 403. At 215, the software 403 determines whether the patient data is a particular priority, such as priority 1 data. If so, then the software 403 assigns that data to a queue, such as a sending messaging queue, under a priority 1 category. If not, then the software 403 proceeds to determine whether the data is a priority 2 data (or other lower priority) and continues to iteratively determine the assigned priority for the data and assigning that data to an appropriate, corresponding category in the sending messaging queue.

After a predetermined time period or upon the occurrence of some predetermined trigger event (such as, in a non-limiting example, the queue reaching a maximum filled volume or achieving other predetermined criteria), the software 403 then transmits the data of the sending messaging queue in order of priority over the telemedicine network to an appropriate location such as the healthcare facility. In this manner, the data is captured in the sending messaging queue in a prioritized manner and sent over the network in order of priority.

Pursuant to an example of the data throttling process, priorities are established and a priority is determined for a particular data type, wherein any number of data types may be assigned a priority. The data types and the corresponding priorities may be static in that they do not change once they are set by a user. In another embodiment, the data types and corresponding priorities may be automatically or manually updated based on dynamic needs. A mechanism for measuring the health or capability of the communication network health is also established. The health or capability of adjudication network may be represented, for example, by bandwidth, jitter, latency, or other criterion as defined by need.

Next, trigger points or conditions for when each data priority is affected or acted upon, such as when the data is sent to over the network, are established. The trigger points may be based on available bandwidth. In a non-limiting example, the conditions may specify that (1) only Priority 1 data for all communication connections to the network lower than 250 kbps is sent to the network; (2) Priority 1 and Priority 2 data for all connections lower than 500 kbps is sent; (3) Priority 1,2,3 data for all connections lower than 1 Mbps is sent; and (4) Priority 1-4 data for all connections greater than 2 Mbps is sent. In addition, Priority 1 through 4 data may be sent for all connections greater than 1 Mbps assuming that the prior conditions addressed all connections less than 1 Mbps. In this non-limiting example set points can be configured statically or dynamically based on end solution need.

In another non-limiting example, data is sent over the network according to a priority scheme using allocated time slots with less or no regard to fixed trigger points based on bandwidth. Data is separated by priority into multiple queues, and one or more time slots, fill levels or other criteria are defined with timeslots being assigned to the various priorities. The time slots, fill levels or other criteria determine the time available to empty the respective priority queues such as based on a round-robin hierarchy. Data for transmission is drawn from each queue.

For example, a highest priority queue is sent first, then lower priority queues are sent descending by priority until: (1) the time slot expires or a fill level is reached for each priority queue; or (2) the queue becomes empty, whereupon data is drawn from the next lower priority queue until that time slot expires, the fill level is reached or the queue becomes empty. This process may continue down the priority chain and upon reaching the lowest priority queue repeats by returning to the highest priority queue. This sequence may be interrupted at any point by a fill level or other event being reached by a higher priority queue whereupon execution jumps to the interrupting queue.

In a next step, additional flow control logic is established including provisions for polling and user controlled prioritization. Then one or more message queues for outgoing data is established. Clean up and maintenance activities are then performed on message queues to avoid memory leaks and/or buffer overflows.

In another non-limiting example, the transmission of data may operate pursuant to a predetermined method. An exemplary method of transmitting data pursuant to a data-throttling scheme is now described. In a first step, a data transmission cycle begins by starting a timer. The timer defines an amount of time that is allocated for transmitting a patient data element. The value of the timer may vary. It may have a default value or a user may program the value of the timer at the point of care location.

In a next step, the software attempts to transmit any unsent patient data elements, with precedence going to the patient data element with the highest priority value. That is, the unsent patient data element with the highest priority is the one that is sent first. If the timer expires prior to all of the highest priority data elements being sent, then the method either terminates or the timer is restarted. The software continues to attempt to send the highest priority data elements as long as the timer is not expired. Once the patient data elements with the highest priority are successfully transmitted, and time remains in the cycle, transmission of the next lower priority data begins. When the timer expires, the method returns to the initial step wherein the timer is restarted and the software attempts to send the patient data element with the highest priority. This process continues until the device has successfully transmitted all patient data elements.

Other factors may be taken into account, such as the time stamp of the patient data element. This may ensure that the data being sent to the home base contains the most recent, most valuable information regarding the patient's condition and care. Specifically, during an individual time cycle of transmission, the data elements of a particular type, e.g. blood pressure, could be sent in order of those with the most recent time stamp first, then proceeding to older entries. The time length of the cycles will be adjustable to allow for fine-tuning.

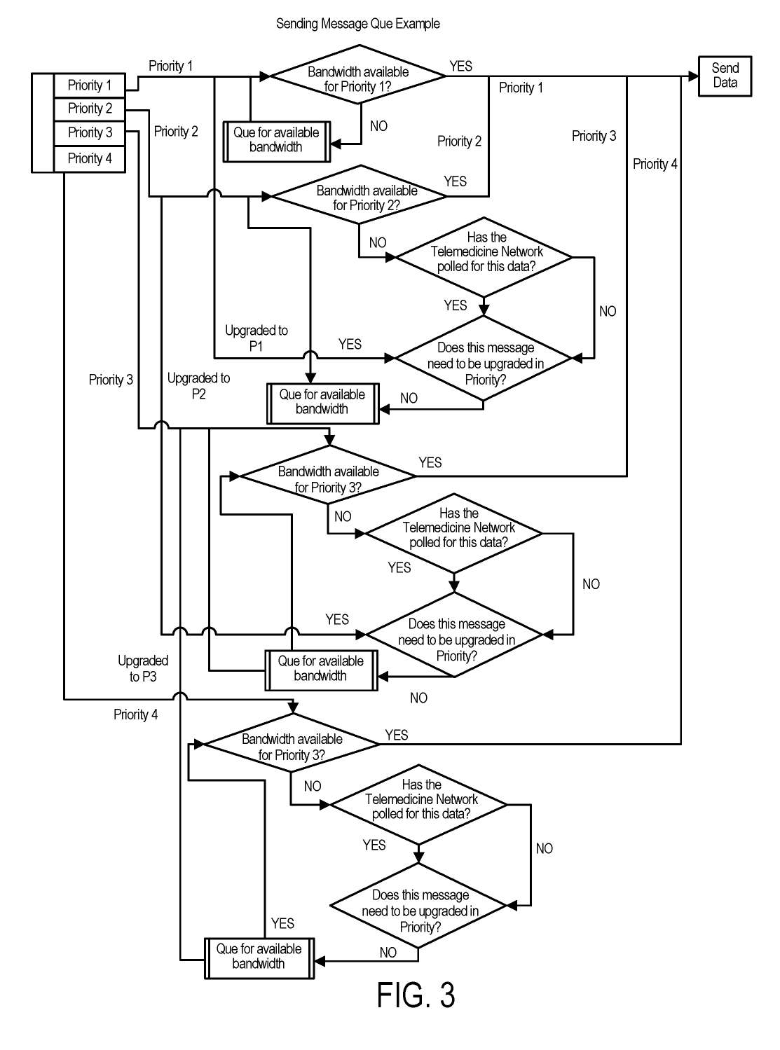

FIG. 3 shows an example of a sending method queue. Starting at the highest priority, the sending queue first determines whether a predetermined amount of bandwidth is available to send data at that highest priority (priority 1). If yes, the system then sends the data for priority one. If no, the system queues the data and waits for available bandwidth. This process iteratively repeats moving downward along the priority chain. For example, the system then determines whether bandwidth is available for priority 2. If yes, then the system sends the data. If no, the system may optionally determine whether the telemedicine network has been polled for data of priority 2. The system may then optionally determine whether the data needs to be upgraded and re-prioritized. If yes, the system will then upgrades the data to the next highest priority, such as priority 1. If no, the system will then queue the data and wait for available bandwidth. If the data is upgraded and prioritized, this may be based on preset rules that are determined by a user. The aforementioned process will repeat moving downward along the priority chain for all available data.

The flow chart of FIG. 3 only includes 4 different priorities although it should be appreciated that any quantity of priorities may be implemented. In the example of FIG. 3, Priority 1 is the highest priority and Priority 4 is the lowest priority. The example includes message queues for both sending and receiving data. It is foreseeable that implementations without the Receiving Message Queue can be implemented and still be successful.

As mentioned, the disclosed method may be implemented pursuant to hardware and/or software.

Data Replication and Synchronization (DR&S)

There is now disclosed a system and method for data replication and synchronization (DR&S), which relates to storing data in a local location until available network bandwidth and/or network connectivity allows for synchronization to take place over an available communication network, which may sometimes be referred to as a Telemedicine Network. The system includes a DR&S server device that maintains compliance with one or more requirements, such as the Health Insurance Portability and Accountability Act (HIPAA). In this regard, the server device encrypts all data at rest and removes data files that are no longer required that have been verified as synchronized with a database such as a Healthcare Record Repository. Pursuant to this process, the software and/or hardware communicates with a communication network. The Healthcare Record Repository may be accessed via the communication network wherein the Healthcare Record Repository stores and maintains one or more Electronic Healthcare Records (EHR). An EHR is a record that is maintained for all patients controlled by a primary healthcare provider or a Health Information Exchange.

It may be common for the healthcare provider, such as a paramedic, to be in a location where the communication network is not accessible such that the healthcare provider cannot access an existing Healthcare Record Repository to query or update the relevant EHR. The healthcare provider may still need to access and/or enter data into the system. In such a situation, the healthcare provider may use a local DR&S server to complete forms and updates to the EHR offline.

In a non-limiting example, the healthcare provider is a paramedic dispatched to a location with no bandwidth or available connectivity to the telemedicine network. The location may be, for example, an industrial basement, apartment building, battlefield or rural area. A central dispatch, for example, may provide the paramedic with information regarding the patient so the paramedic may access an EHR for the patient. While en route to the patient, if there is a network connection available and there is an existing EHR for that patient, the paramedic synchronizes data on the DR&S server with the data on the remote EHR Repository to locally synchronize all pertinent medical records for the visit. The paramedic may also enter patient data manually into a local EHR if there is no connection to a master EHR repository or if the patient does not have an EHR in that repository. The paramedic now has local access to a duplicate or partial duplicate of a master EHR record, if available, on the local DR&S server.

When the paramedic arrives at the treatment location, the paramedic inputs patient data using the disclosed system, such as the system shown in FIG. 1. The DR&S server (or software that resides at the server) intercepts the data entered by the paramedic and makes updates to a local copy of the EHR, which is locally stored temporarily until a connection with a remote server on the communication network is available. The data may be stored, for example at a local data storage device coupled to the user's computer. Any aspect of the DR&S process may be performed by software that resides at the DR&S server. In another embodiment, the software resides on a local computer different from the server.

Assuming that the paramedic is required to care for and transport the patient, during transport the DR&S server periodically checks for the availability of a communication network. When the server detects the presence of an available communication network, the server automatically begins synchronization of data between the DR&S server and the Electronic Data Repository. When synchronization is complete, the server performs a final verification between the DR&S server and the EHR Repository to ensure the patient data history is up to date with current information. In addition, when verification is complete and authority is given, all patient files regarding the case may be deleted from the DR&S server such as in order to comply with HIPAA requirements.

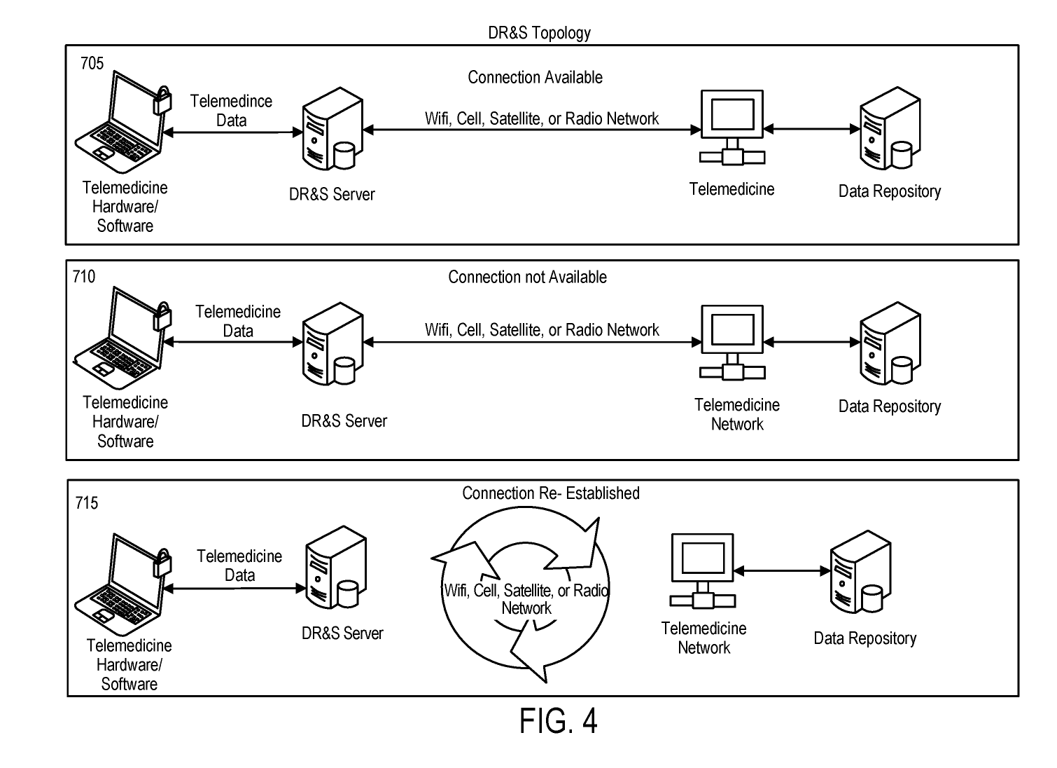

FIG. 4 shows a schematic representation of an example architecture for implementing the aforementioned processes. At 705, when a connection to the network is available, the DR&S Server actively synchronizes data over the Telemedicine Network to the EHR or other electronic data repository. If a connection is verified, the DR&S Server can become a redundant data repository until a confirmation is received from the electronic data repository that all data has been correctly received.

At 710, when a connection to the Telemedicine Network is not available, the DR&S Server detects the lack of connection to the Telemedicine Network and actively serves up the required data to a local hardware and/or software so that the data update may complete offline. This is especially useful when filling out forms and other chart type information that can later be synchronized with the Electronic Data Repository. This allows telemedicine activities to occur where no bandwidth is available by providing a user with local access to the data.

At 715, the DR&S server is prepopulated with information such that a paramedic or other medical personnel can load patient information and record information that they will be serving throughout the day. The DR&S server acts as a temporary storage location for all data until a connection with the Telemedicine Network is established and a full synchronization between the DR&S Server and the electronic data repository can occur. Upon completing of data synchronization, all records are verified to be accurate both in the electronic data repository and the DR&S server before data is removed from the DR&S server.

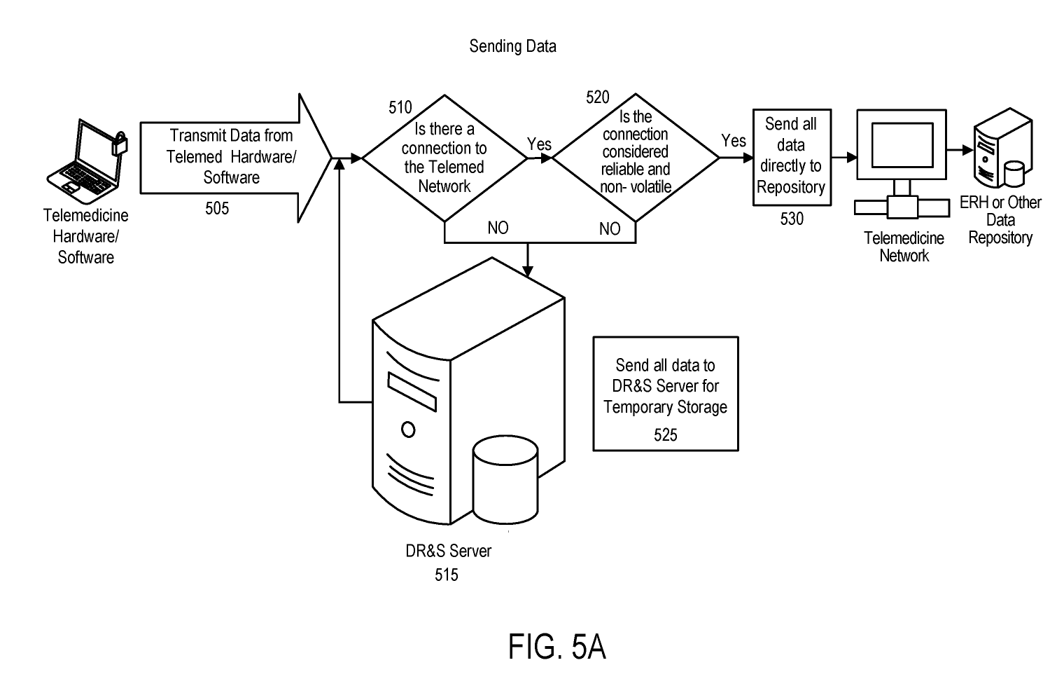

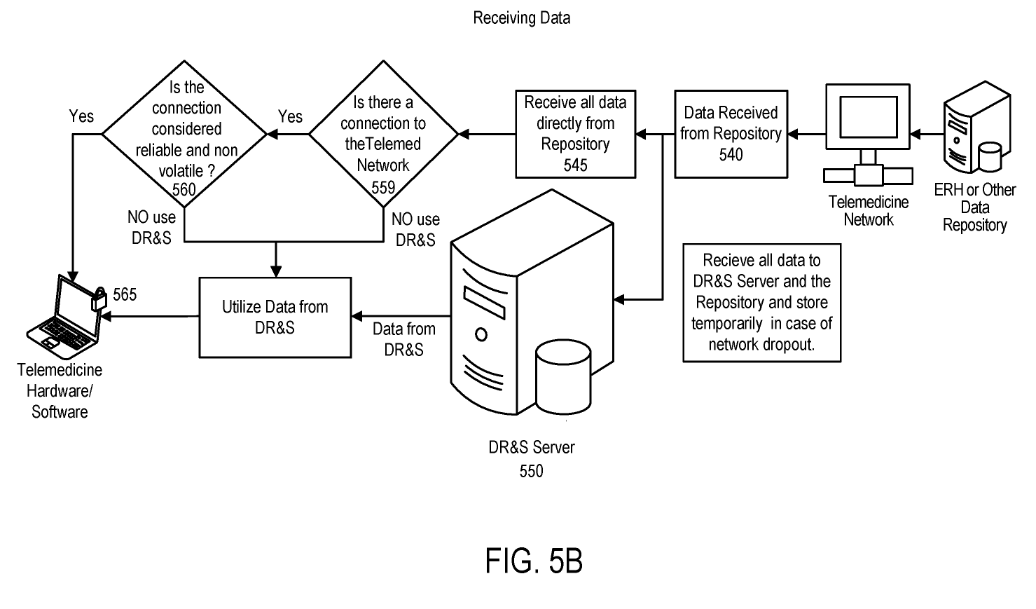

FIG. 5A and FIG. 5B show representations of exemplary methods of implementing the aforementioned processes both for sending data and receiving data. FIG. 5A shows an exemplary method of sending data. In a first step 505, a local device attempts to transmit data over the network. Available software determines whether there is a suitable connection to the network at 510. If not, the data is sent to the local DR&S server for temporary storage at 515. If yes, it is then determined whether the connection to the network is considered reliable and non-volatile at 520. If not, at 515 the data is sent to the DR&S server in the repository in case the connection to the network fails or is interrupted. If yes, then the data is sent to the data repository over the network at 530 of the process.

FIG. 5B shows an exemplary method of receiving data from the data repository. In an initial step 540, data is received over the network from the repository. At 545, it is determined whether there is a connection to the telemedicine network. If not, the server receives all the data for temporary storage at 550. The server also stores the data at 550 in case the network fails or network connection is interrupted. If yes, it is determined whether the connection to the network is considered reliable and non-volatile at 559. If yes, a local device receives all data directly from the repository at 560. Otherwise, the local device receives data from the DR&S server at 565.

Medical Agnostic Device Interface (MADI)

Also disclosed herein is a light weight software capability that is installed on a computer to provide an agnostic interface to any medical device that readily provides a data output stream for access by the medical community. The software may be an extension to an existing software application already installed on the computer. The software is in the form of a Medical Agnostic Device Interface (MADI), which may be a user interface that is loaded as part of a website or is installed on an Internet browser in the form of a plugin or other simple browser update or HTML code. The MADI allows health care physicians to connect to any number of medical devices while utilizing simple browser related software to interface to each which allows for a quick and painless integration. Examples of medical devices that may be supported by the MADI include, but are not limited to: Exam cameras, Electrocardiograms (ECG or EKG), Ultrasound devices, Blood Pressure Monitors, Blood Glucose Meters, and Stethoscopes.

In an example, the healthcare provider is a healthcare professional on site with a patient performing a diagnosis. The healthcare professional needs to access and/or distribute medical data over a Web browser-based device. The healthcare professional notices that the ECG device that is present has never been used for a telemedicine consult. The healthcare professional then plugs the ECG device into a local computer hosting the Telemedicine consult via USB, Ethernet, Serial Bus, Bluetooth, WiFi or other interface. The local computer may be for example the telemedicine hardware device 410. The disclosed telemedicine browser environment automatically detects the addition of the added peripheral and automatically updates to offer plug and play capability at the browser level. This avoids the healthcare professional requiring administrative access to his or her local machine in order to perform the required install. This offers an agnostic and easy way to use plug and play interface that will work for all medical diagnostic devices in an Internet browser environment.

The system is configured to protect user data while also providing an interface that enables a user to remotely view the data in a protected manner with the user using any device that can access the network. Thus, the user does not have to use a specially configured device or location to access the data. Rather, the user can bring his or her own device. This is achieved by only utilizing the device as a means of viewing the data, such as in “looking glass” into the protected data with the protected data hosted in a secure location. When accessing the system, a temporary secure/encrypted connection is established between the secure location where the data is hosted and the user's device that is accessing the data. All protected information is stored in the protected location (such as the “Cloud” or Internet) and is never stored permanently on the device used to access the system. As soon as there is a connection break, the application is closed, or the user logs out all temporary files and records are flushed. This system allows a user to bring his own device or to utilize non-medically controlled or public devices to access and perform telemedicine activities.

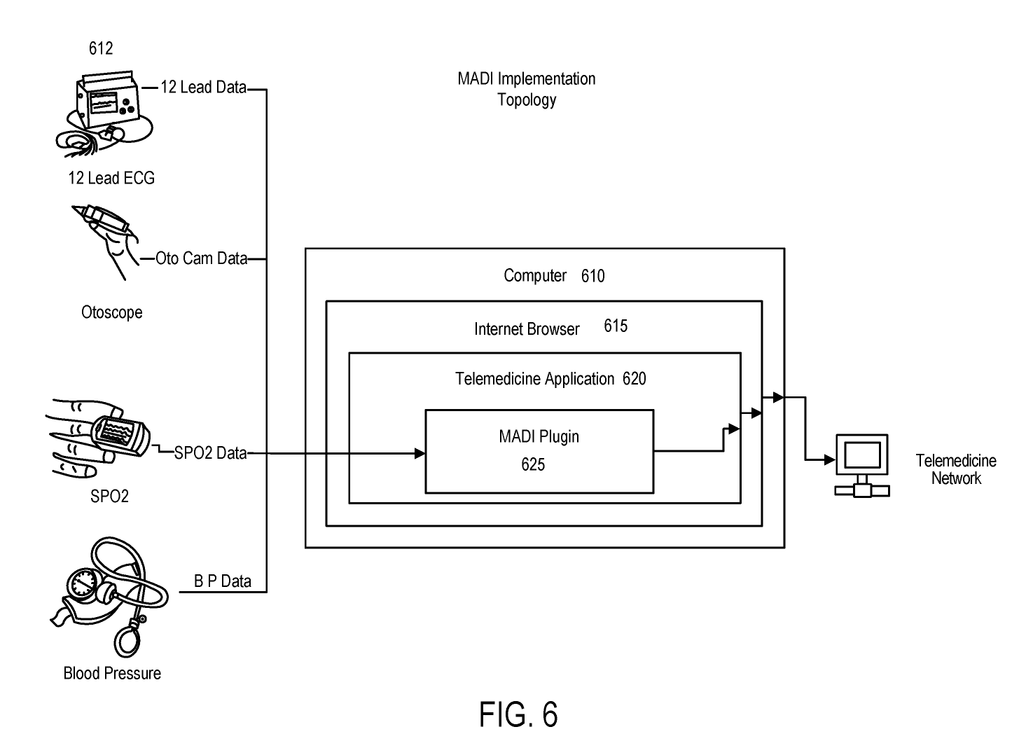

FIG. 6 shows an exemplary topology for implementation of the MADI. As shown in FIG. 6, a local computer 610 is communicatively coupled to one or more medical devices 612 via USB, Ethernet, Serial Bus, Bluetooth, WiFi or other wired or wireless interface. A local Internet browser 615 resides on the computer 610 and communicates with a telemedicine application 620. The type of medical device 612 that is coupled to the computer can vary.

The telemedicine application 620 can reside locally on the computer or it can reside remotely, such as on the telemedicine network. In any event, the telemedicine application 620 communicates with the telemedicine network. A remote user can also have access to a separate instance of the telemedicine application on his or her own local computer. In this manner, a clinician can communicate with the remote user regarding medical related information using the telemedicine applications and communicating over the telemedicine network.

The telemedicine application 620 communicates with the medical device(s) 612 via a Medical Agnostic Device Interface (MADI) plug-in that sits on top of the telemedicine application 620. In an embodiment, the telemedicine application includes a user interface that provides a means for the user to provide medical related information to the telemedicine application. Some embodiments of the user interface are now described.

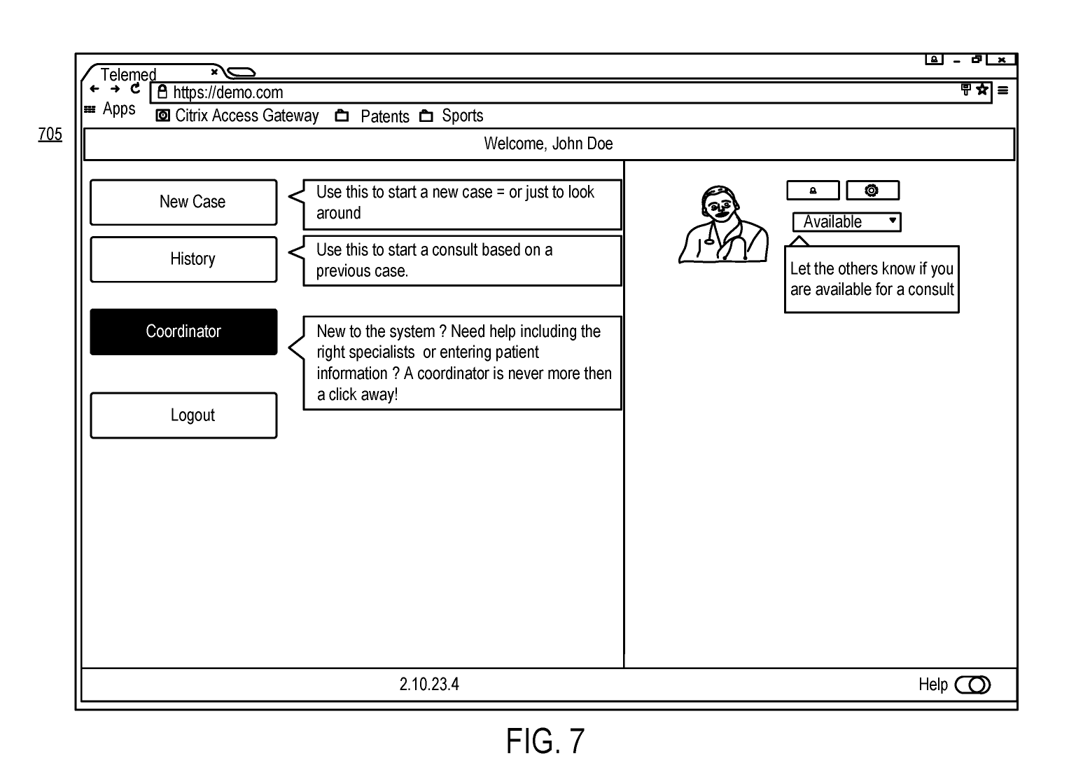

FIG. 7 shows a screenshot of a user interface 705. The user interface 705 may be accessed using a standard web browser, and by providing a username and password. In the illustrated embodiment, the user interface 705 includes one or more fields or links that permits the user to navigate the application or any aspect of the user interface. For example, the user interface 705 includes a “New Case” link that a user can click on to create a data file associated with a new patient. The user interface also includes a “History” link that can be clicked on to access data based on a previously created case. In addition, the user interface 705 includes a “Coordinator” link that the user can access to obtain help or information related to the application. A “Logout” link can also be included.

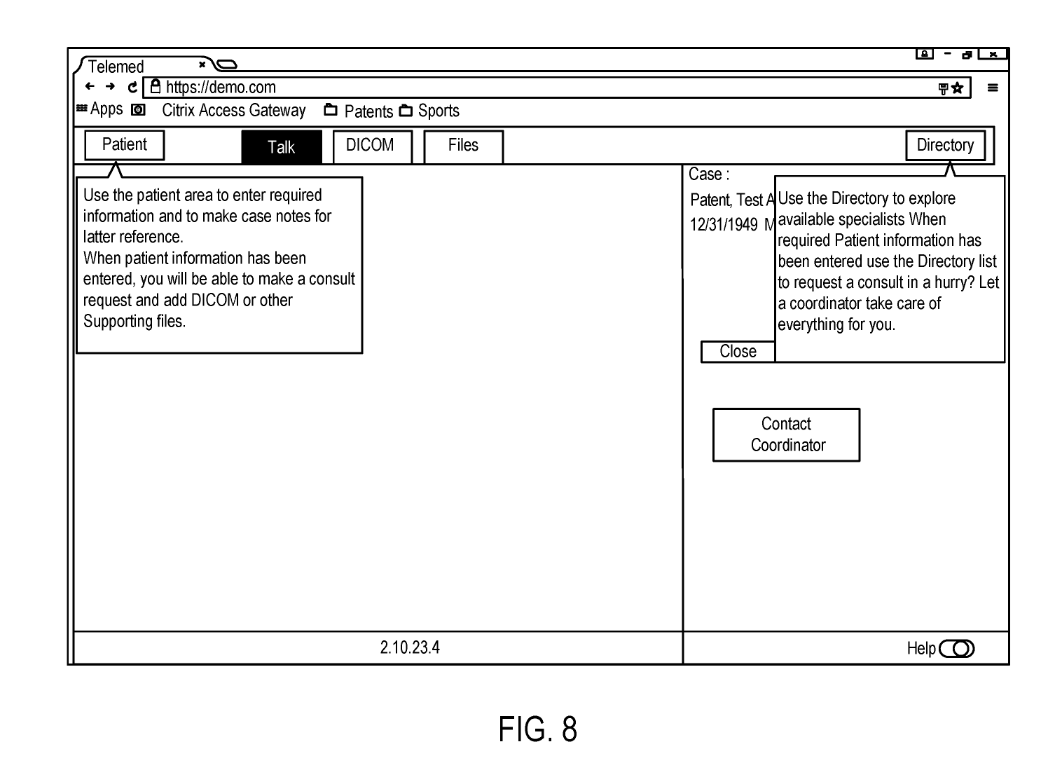

When a user accesses a new or previously created case, a data access user interface is presented, as shown in FIG. 8. The data access user interface can be used to access various data associated with the case. This user interface can also be used to establish a communication link to enable audio and/or visual communication with another user located at a remote location. In this regard, the user interface includes one or more tabs such as a “Talk” tab that the user can click on to establish a communication link.

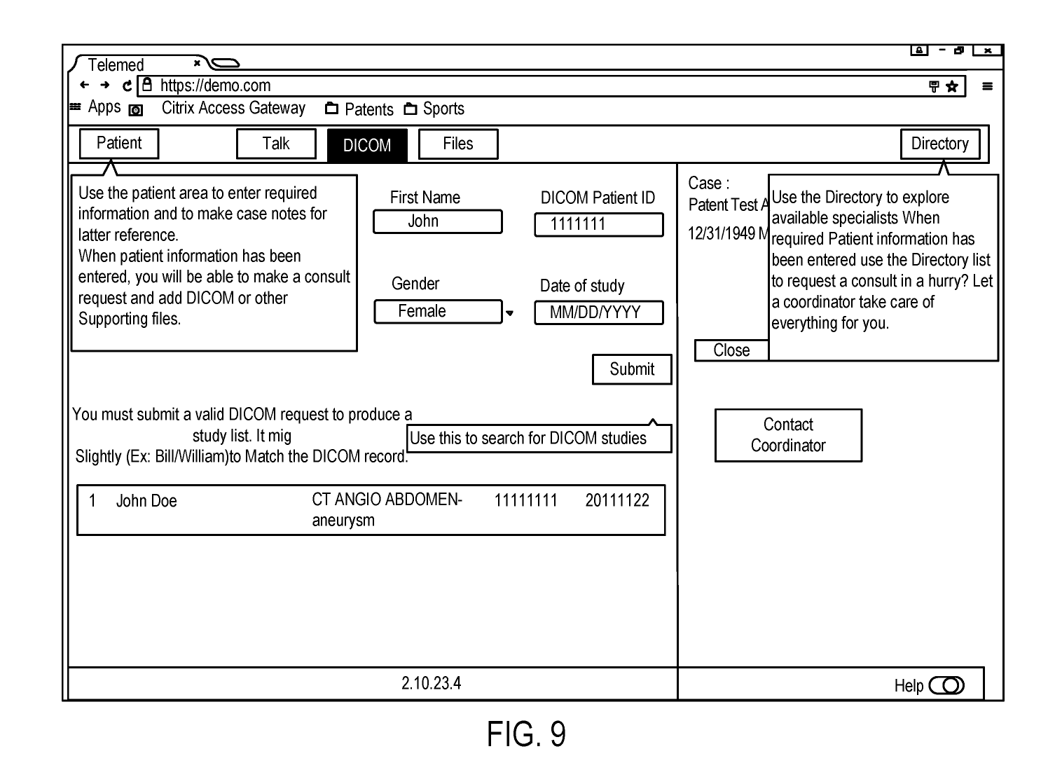

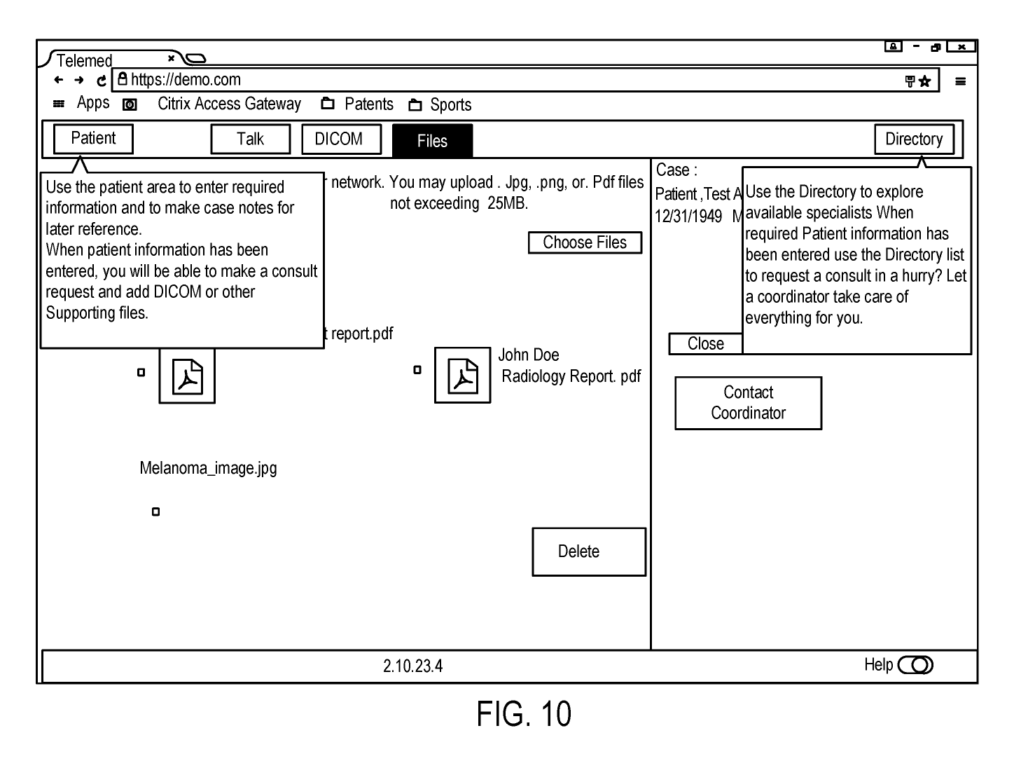

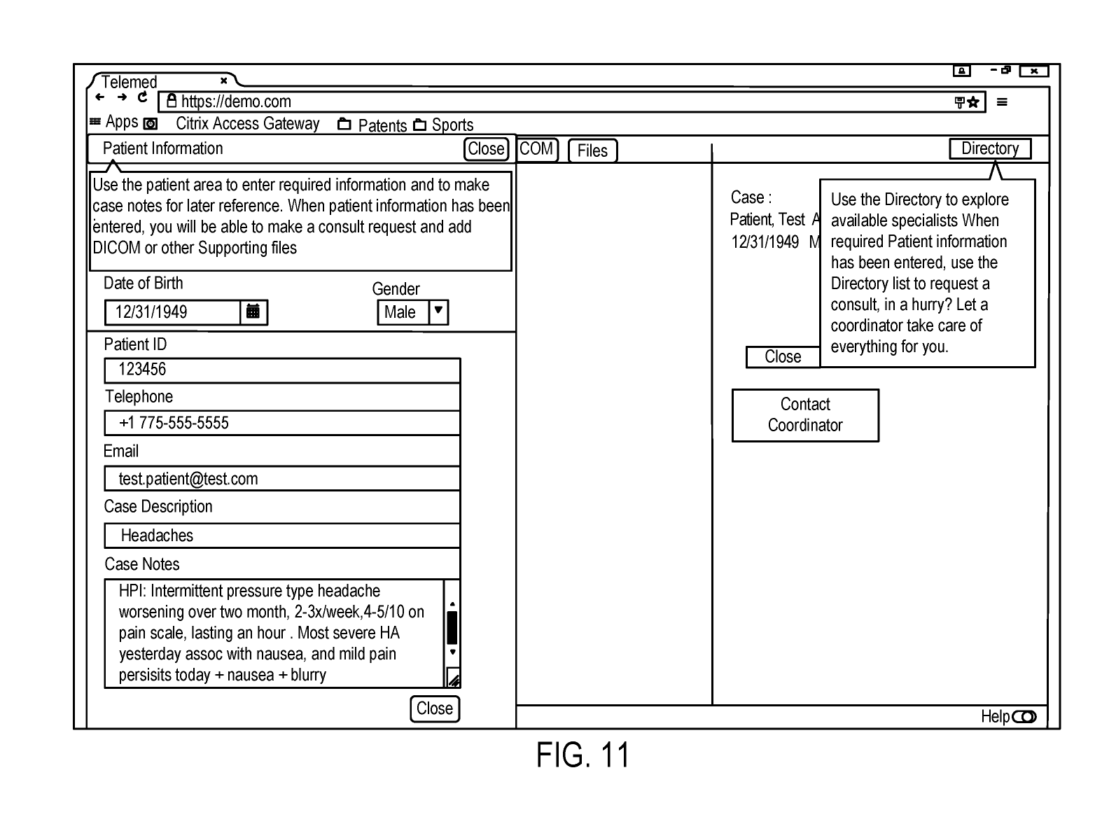

In an embodiment shown in FIG. 9, the user can also access a “DICOM” link to access and save one or more Digital Imaging and Communications in Medicine (DICOM) files. As shown in FIG. 10, the user can also access a “Files” link that can be used to store, access, and save any of a variety of computer files. In addition, as shown in FIG. 11, the user interface includes one or more fields that permits the user to enter patient related data.

It should be appreciated that the user interface is shown herein are just examples and that any of a variety of user interfaces may be configured in any of a variety of manners to permit the user to access, input or otherwise share patient data and related data.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a device having a display device, such as for example a liquid crystal display (LCD) monitor for displaying information to the user and a keyboard and an input device, such as for example a mouse or a trackball, by which the user may provide input to the device. Other kinds of devices can be used to provide for interaction with a user as well. For example, feedback provided to the user can be any form of sensory feedback, such as for example visual feedback, auditory feedback, haptic or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

Other possible input devices include virtual reality (VR) and augmented reality AR) input mechanisms including, for example, 3D cameras and tactile feedback devices such as tactile feedback gloves. A virtual reality headset can also be used for the input and/or review of data. The AR and VR aspects of the system, when present, can be combined in a variety of ways to extend telemedicine to senses beyond just sight and hearing. This may allow for a more complete assessment of the patient by a reviewing party such as a physician. For example, an AR or VR interface can be used to permit the physician at a remote location to actually feel pulse and textures without having to be physically next to the patient.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) when depicted in the accompanying figures and/or described herein do not necessarily require the particular order shown, or sequential order, to achieve desirable results. Other implementations may be within the scope of the following claims.

1. A method of managing medical related data, the method comprising:
receiving a request from a local computer to send at least a first set of medical data to a remote data repository, wherein the data repository is accessible only via a telecommunication network;
determining a status of a network connection between the local computer and the telecommunication network;
based on the determined status, either sending the first set of medical data over the telecommunication network to the remote data repository or saving the first set of medical data to a local server without sending the first set of medical data to the remote data repository.

2. The method of claim 1, wherein the first set of medical data is sent over the telecommunication network to the remote data repository if it is determined that a connection to the telecommunication network is present.

3. The method of claim 1, wherein the first set of medical data is sent over the telecommunication network to the remote data repository if it is determined that a connection is reliable and non-volatile.

4. The method of claim 1, wherein the first set of medical data is saved to the local server without sending the first set of medical data to the remote data repository if it is determined that a connection to the telecommunication network is not present.

5. The method of claim 1, wherein the first set of medical data is saved to the local server without sending the first set of medical data to the remote data repository if it is determined that a connection to the telecommunication network is not reliable.

6. The method of claim 1, further comprising encrypting the first set of medical data prior to sending or saving the first set of medical data.

7. The method of claim 1, further comprising synchronizing the first set of medical data with data on the remote data repository so that the first set of medical data is replicated at the remote data repository.

8. The method of claim 7, further comprising deleting the first set of medical data from the local server after synchronizing.

9. The method of claim 1, further comprising:
periodically re-determining the status of the network connection if it is initially determined that that the network connection between the local computer and the telecommunication network is unavailable or unreliable.

10. The method of claim 1, further comprising:
periodically updating the first set of medical data in the local server if it is initially determined that that the network connection between the local computer and the telecommunication network is unavailable or unreliable.

11. The method of claim 1, further comprising:
initially determining that a network connection is unavailable or unreliable;
saving the first set of medical data to a local server without sending the first set of medical data to the remote data repository; and
sending the first set of medical data over the telecommunication network to the remote data repository once it is determined that the network connection has become available.

12. The method of claim 11, further comprising:
deleting the first of medical data from the local server.

13. The method of claim 1, further comprising:
prioritizing data elements from the first set of medical data;
sending higher priority data elements over the telecommunication network to the remote data repository;
sending lower priority data elements over the telecommunication network to the remote data repository only after the higher priority data elements have been sent.

14. The method of claim 1, further comprising:
prioritizing data elements from the first set of medical data;
sorting the prioritized data elements into at least one queue prior to sending any of the medical data over the telecommunication network to the remote data repository.

15. The method of claim 1, further comprising:
obtaining at least a portion of the first set of medical data directly from a medical device.

16. The method of claim 15, further comprising:
automatically determining a type of medical device without requiring a user to manually enter information related to the medical device.

17. The method of claim 7, further comprising synchronizing the first set of medical data with data on the remote data repository prior to receiving the request from the local computer.

18. The method of claim 1, further comprising:
receiving a request from a local computer to send a second set of medical data to a remote data repository;
determining a status of a network connection between the local computer and the telecommunication network;
based on the determined status, either sending the second set of medical data over the telecommunication network to the remote data repository or saving the second set of medical data to a local server without sending the second set of medical data to the remote data repository.

19. The method of claim 1, further comprising:
receiving a request from a local computer to send a third set of medical data to a remote data repository;
determining a status of a network connection between the local computer and the telecommunication network;
based on the determined status, either sending the third set of medical data over the telecommunication network to the remote data repository or saving the third set of medical data to a local server without sending the third set of medical data to the remote data repository.

20. A computer-implemented method for transmitting medical data-related comprising:
receiving a request to transmit patient data elements, wherein each patient data element is a piece of information that is relevant to patient care;
determining an assigned priority of each of the patient data elements to be transmitted;
sorting the patient data elements in at least one queue based on the assigned priority of each patient data element;
determining an available communication bandwidth for transmitting data over a network;
transmitting the patient data elements based upon the available communication bandwidth and the assigned priority.

21. The method of claim 20, further comprising storing data elements in at least one queue based on the assigned priority of each data element.

22. The method of claim 20, wherein the patient data elements are not transmitted until a trigger occurs.

23. The method of claim 22, wherein the trigger relates to a passage of a predetermined amount of time.

24. The method of claim 22, wherein the trigger relates to the available communication bandwidth being above a minimum value.

25. The method of claim 22, wherein the trigger relates to the available communication bandwidth being within a predetermined range.

26. The method of claim 22, wherein the trigger relates to a queue reaching a predetermined value.

27. The method of claim 22, wherein the trigger relates to a queue reaching a maximum filled volume.

28. The method of claim 20, wherein higher priority patient data elements are transmitted before lower priority data elements.

29. The method of claim 20, wherein there are multiple queues, each queue being associated with a priority.

30. The method of claim 20, wherein the patient data elements are automatically assigned a default priority.

31. The method of claim 20, wherein the patient data elements are manually assigned a priority.

32. The method of claim 20, further comprising revising the priority of at least one of the patient data elements.

33. The method of claim 18, further comprising clearing a queue after a predetermined period of time.

34. The method of claim 20, further comprising clearing a queue of data elements based on occurrence of a trigger event.

35. A program configured to provide communication between a computing device and a medical device, wherein the program automatically detects a medical device connected to the computing device and provides a stream for transferring data between the medical device and the computing device.

36. The program of claim 35, wherein the program is a software plug-in or an extension.

37. The program of claim 35, wherein the program provides a visual interface for a user to communicate with the medical device.

38. The program of claim 35, wherein the program automatically detects the type of medical device.

39. The program of claim 37, wherein the visual interface is part of an Internet browser.

40. The program of claim 35, wherein the program resides locally on the computer or remote to the computer.

41. The program of claim 35, wherein the program comprises a Medical Agnostic Device Interface (MADI).

42. The program of claim 35, wherein the program is a stand-alone application.
